(19) United States
(12) Patent Application Publication
(10) Pub. No.: US 2005/0186312 A1
(43) Pub. Date: Aug. 25, 2005

(54) Shelf-stable foodstuffs and methods for their preparation

(75) Inventors: Jimbay P. Loh, Green Oaks, IL (US); Laura G. Hill, Prospect Heights, IL (US); Yeong-Ching A. Hong, Kildeer, IL (US); Tim Hansen, Chicago, IL (US); Alice S. Cha, Northbrook, IL (US); Veronica M. Harrison, Bartlett, IL (US); Colin P. Crowley, Wheeling, IL (US); Iksoon Kang, Madison, WI (US); John A. Hirschey, Middleton, WI (US); Erik K. Whalen-Pedersen, Spring Grove, IL (US)

Correspondence Address: KRAFT / FETF, 120 S. LASALLE STREET, SUITE 1600, CHICAGO, IL, 60603-3406, US

(73) Assignee: Kraft Foods Holdings, Inc.

(21) Appl. No.: 10/956,907

(22) Filed: Oct. 1, 2004

Related U.S. Application Data
(63) Continuation-in-part of application No. 10/784,404, filed on Feb. 23, 2004.
(63) Continuation-in-part of application No. 10/784,699, filed on Feb. 23, 2004.
(63) Continuation-in-part of application No. 10/941,578, filed on Sep. 15, 2004.

(51) Int. Cl. A23L 1/30

(52) U.S. Cl. 426/326

(57) ABSTRACT

Low pH, high moisture, shelf stable foodstuff and methods of making are provided. The foodstuff is acidified with acidic electrodialized composition, edible inorganic acid or mixture thereof to obtain a final product pH of 4.6 and preferably 4.3 or less. The low pH foodstuff has total organic acids content of 0.12 moles per 1,000 grams of foodstuff or less and is heated to a temperature of 165° F. to pasteurize. New or improved, shelf stable, non-sour food components and products and their methods of preparation are also provided.

The present application is a continuation-in-part application of U.S. patent application Ser. Nos. 10/784,404 and 10/784,699 both filed Feb. 23, 2004 and of U.S. patent application Ser. No. 10/941,578, filed Sep. 15, 2004, all of which are hereby incorporated by reference.

The present invention is directed to shelf-stable food compositions and methods for their preparation. More specifically, foodstuffs are prepared with electrodialyzed composition and/or inorganic acids in amounts effective for providing a low pH foodstuff with enhanced shelf-stability and acceptable taste and organoleptic properties. Preferably, the food compositions of this invention are substantially free of organic acids.

### BACKGROUND

Food processing often requires pH adjustments to obtain desired product stabilities. The direct addition of food acidulants (such as lactic acid) inevitably leads to significant (often negative) alterations in taste in such acidified foods. Low pH products may also result in undesirable precipitates which detract from the organoleptic quality of the food and make additional processing more difficult.

One alternative to adding food acidulants to foods is to use compositions generated by electrolysis and/or electrodialysis. Electrodialysis (ED) is used in connection with the separation of dissolved salts or other naturally occurring impurities from one aqueous solution to another aqueous solution. The separation of these dissolved salts or other impurities results from ion migration through semi-permeable, ion-selective membranes under the influence of an applied electric field that is established between a cathode (negative potential electrode) and an anode (positive potential electrode). The membranes may be selective for monovalent or multivalent ions depending on whether separation is desired between monovalent or multivalent cations and/or anions. The separation process results in a salt or impurity concentrated stream (known as a concentrate or brine) and in a salt or impurity depleted stream (known as a diluate). The concentrate and diluate streams flow in solution compartments in the electrodialysis apparatus that are disposed between the anode and cathode and that are separated by alternating cation and anion selective membranes. The outer most compartments adjacent the anode and cathode electrodes have a recirculating electrode-rinse solution flowing therethrough to maintain the cathode and anode electrodes clean.

Low cost, high quality dairy products are largely unavailable in shelf stable form. Expensive Processes such as retort treatment or aseptic packaging have been used to prepare shelf stable dairy products; these processes are, however, very expensive. Others use intermediate moisture preservation technology mainly depending on the use of humectants (e.g. glycerol) and preservatives (e.g. high salt, sorbic acid) which yield high solid, inferior products (e.g. rubbery or candy-like texture, unacceptable taste). Use of acidification with organic acid to provide a shelf stable dairy product leads to problems which may include (1) isoelectric precipitation of casein leading to grainy texture, emulsion breakdown, etc. and (2) most importantly unacceptable sour taste.

Fresh fish tend to not be very shelf stable and normally have to be used very quickly. In some fish, especially, for example, in Arrowtooth Flounder and Pacific Whiting, protease enzymatic activity results in a softening and disintegrating of muscle structure. This and other adverse enzymatic activities often result in the removal of otherwise marketable fish from the market. Acidification to a lower pH range has been found to inactivate protease enzyme. However, acidification with food acidulants results in undesirable off-flavors and objectionable sourness.

### SUMMARY

The present invention is broadly directed to methods for acidifying foodstuffs which are effective for enhancing their shelf-stability while not introducing a sour taste or adversely effecting organoleptic properties of the foodstuffs. Acidification of the foodstuffs is effected by membrane electrodialysis and/or addition of inorganic acids. The use of membrane acidic electrodialyzed composition (ED) and/or inorganic acids is effective for lowering pH without addition of organic acids which may result in unacceptable sour taste in the foodstuff.

Clean tasting, acidic ED compositions may be prepared and used for lowering the pH of foods. Use of non-toxic inorganic acids is another alternative to adding food acidulants to foods. Inorganic acids include hydrochloric acid, sulfuric acid, metal acid sulfates and the like. However, the use of these alternatives to food acidulants alone may not always eliminate or significantly reduce perceived sourness in the resulting low pH (4.2 or less) foods and provide an acceptable product. Maintaining a low level of total organic acid in a given product (as consumed) is important in providing an acceptable product. Effective ingredient selection and formulation to lower organic content in finished products is needed for some formulated food products to provide acceptable products.

In one aspect, shelf-stable foodstuffs and methods for preparing a shelf-stable foodstuff are provided. The methods include preparing the foodstuff with ED compositions, an edible inorganic acid, or mixtures thereof in amount effective for providing the foodstuff with a final pH of 4.6 or less, in another aspect, a pH of 4.3 or less, and in another aspect a pH of 4.2 or less.

The method is effective for providing a shelf-stable foodstuff which does not have a sour taste normally associated with low pH foods by maintaining a lower organic acid content (i.e. essentially free of organic acids). The foodstuff will have a total organic acid content of about 0.12 moles per 1000 grams of foodstuff or less, preferably a total organic acid content of about 0.06 moles per 1000 grams or less, and an A_{w} of about 0.75 or greater, in another aspect about 0.85 or greater, and in another aspect about 0.90 or greater. For prepared foods this may be obtained by ingredient selection and/or modification. More preferably, no organic acids are added to the foodstuff. Foodstuffs which may be prepared with this method include sauces, gravies, spreads, dips, dressings, salads, vegetables, starches (rice, potato, pasta, noodle, etc.), meats, sea foods, cereals, baked goods, fillings, toppings, baked goods, confection, beverages, desserts, snacks, and mixtures thereof. To provide microbiological stability, acidified foodstuffs may also be pasteurized in combination with acidification by heating to a temperature of 165° F. or greater.

In another aspect, a shelf-stable dairy product and a method for preparing a shelf stable dairy product are provided. The method includes blending about 2 to about 12 weight percent whey protein concentrate powder with ED composition (i.e. ED water) or inorganic acid solution, or mixtures thereof, in an amount effective for providing a pH of 4.3 or less, and in another aspect a pH of 3.5 or less. A shelf stable, low pH texturized whey protein base may be prepared by mixing and heating the acidic whey protein base to about 180° F. to about 205° F. for about 5 to about 20 minutes to provide texture and convert low viscosity whey protein solution into a thick gel. Defoaming agent may be added prior to heating. This low pH (i.e. 4.0 or less), shelf stable, texturized whey protein base may be used to prepare non-sour dairy products. The dairy product has a total organic acid content of about 0.12 moles per 100 grams of finished dairy product or less.

The texturized whey protein base may be further blended with additional whey protein concentrate and base (if needed) in amounts effective for providing a pH of 4.6 or less. In this aspect, about 0 to about 8 weight percent of the additional whey protein concentrate is blended with the texturized whey protein base and the blend is heated at about 175° F. to about 205° F. for at least about 1 minute to pasteurize and help dissolve added WPC. This texturized and pH adjusted (i.e. 4.6 or less) base can be stored under refrigeration condition and further used to prepare non-sour dairy products.

In another aspect, a method is provided for increasing structural integrity and shelf-life of fish which does not introduce objectionable sourness. Fish are contacted with ED composition, edible inorganic acid, or mixtures thereof in an amount effective for providing a pH of 4.5 or less, and in another aspect a pH of 4.0 or less. Inorganic acids that may be utilized include hydrochloric acid, sulfuric acid, sodium bisulfate, potassium bisulfate, and mixtures thereof. ED composition and/or inorganic acid may be injected into the fish and/or infused into the fish. The treated fish can be packaged and distributed either frozen or refrigerated. Alternatively, treated fish may be cooked (e.g. grilled) and then packaged for distribution. Fish treated in accordance with this method and then cooked have significantly improved texture without the sourness or off-flavors commonly associated with low pH in fish. In addition, firm and flaky texture of cooked fish fillet is preserved.

In another aspect, a method is provided for preparing a shelf-stable cream cheese or cream cheese-like product. The method includes first fermenting a dairy mixture to a pH of 4.4 or higher, preferably 4.8 or higher. The fermented mixture is then acidified to a pH of 4.3 or less, preferably 4.2 or less with acidic ED composition, inorganic acid, or mixtures thereof. The cream cheese or cream cheese-like product is heated to a temperature of 165° F. or higher and the resulting product has a total organic acid content of about 0.22 moles or less per 1000 grams of product. Alternatively, the dairy mixture may be directly acidified without fermentation to a pH of 4.3 or less with ED composition, inorganic acid, and mixtures thereof. In another alternative embodiment, the dairy mixture may be acidified without fermentation to a pH of 4.3 or less with acidic ED composition, inorganic acid, or mixtures thereof and at least one organic acid. Organic acids which may be used include lactic acid, acetic acid, and mixtures thereof. The shelf stable cream cheese or cream cheese-like product may further include added colorants, flavors, nutrients, antioxidants, herbs, spices, fruits, vegetables, seafoods (salmon), nuts and/or other food additives.

In another aspect, high moisture milk and dairy products and methods for their production are provided. The method includes acidifying milk, milk derivatives, or mixtures thereof to a pH of 4.6 or less with acidic ED composition, inorganic acid, or mixtures thereof to provide an acidified mixture. At least one hydrocolloid stabilizer is added to the acidified mixture. The resulting milk or dairy product has a moisture content of 45% by weight or more, a water activity of 0.9 or greater, and a total organic acid content of about 0.2 moles per 1000 grams of said product or less. The milk or dairy product may further include colorants, flavors, nutrients, antioxidants, herbs, spices, fruits, vegetables, seafoods (salmon), nuts and/or other food additives.

### BRIEF DESCRIPTION OF THE DRAWINGS

FIG. 1 is one example of a membrane electrodialysis system for decreasing pH.

FIG. 2 is another example of a membrane electrodialysis system for decreasing pH.

### DETAILED DESCRIPTION

Shelf stable, non-sour tasting foodstuff may be prepared by acidification with acidic ED compositions, edible inorganic acid, or mixtures thereof and by minimizing total organic acid content. As described below, an aqueous solution is used as a feed stream and is processed using membrane electrodialysis to form the ED composition. The ED composition may be used in the formulation and/or preparation of the product. ED compositions and inorganic acids used herein are suitable for human consumption. As used herein “suitable for human consumption” means free from harmful or unapproved chemical(s) or contaminants and objectionable flavor or taste.

ED compositions may be used in the preparation a wide variety of shelf-stable food products. As used “shelf stable food products” generally means the preserved food products stored under ambient conditions are safe for consumption. “Shelf-life” means shelf life under ambient storage conditions. Product shelf life is determined by organoleptic or eating quality of products. Product stability is determined by safety or microbiological stability. If a refrigerated distribution and storage system is used “shelf life” and “product stability” can be extended. In an important aspect, shelf lives of about one to six months are obtained for refrigerated products and shelf lives of about six to nine months are obtained for ambient stable products.

Edible Inorganic Acids. Edible inorganic acids which may be used in the invention include hydrochloric acid, sulfuric acid, sodium bisulfate, potassium bisulfate, and mixtures thereof.

Total Organic Acid Content Total organic acid content in a food product can influence the perceived sourness intensity. The “organic acids” in a preserved food mainly come from the added edible food acidulants including, but not limited to, acetic acid, adipic acid, citric acid, fumaric acid, gluconic acid, lactic acid, malic acid, phosphoric acid and tartaric acid. Natural occurring organic acids in food ingredients will also contribute to perceived sourness. Thus “total organic acid content” is defined hereafter as the sum of all the above-mentioned food acidulants and all natural occurring organic acids (including those not mentioned above such as oxalic acid, succinic acid, ascorbic acid, chlorogenic acid and the like). An organic acid profile can be readily obtained using appropriate analytical method such as S. Rantakokko, S. Mustonen, M. Yritys, and T. Vartiainen. Ion Chromatographic Method for the Determination of Selected Inorganic Anions and Organic Acids from Raw and Drinking Waters Using Suppressor Current Switching to Reduce The Background Noise from Journal of Liquid Chromatography and Related Technology (2004); 27, 821-842. The quantity of individual organic acids can be measured and summed up to give “total organic acid content” which is conveniently expressed in “moles per 1000 grams of finished foodstuff”.

Aqueous Solution. Aqueous feed solutions which may be treated with the ED method to produce acidic ED composition include any mineral or ion rich aqueous solution obtainable from natural water sources such as spring water, well water, municipal water, sea water and/or artificially ion enriched water free from contamination and excessive chlorination (for example greater than about 2 ppm of free chlorine). An aqueous feed solution for ED treatment should have a total cation or total anion concentration of about 0.0001N to about 1.8N which is effective for providing an initial conductivity of about 0.1 to about 200 mS/cm. As used herein, “total cation concentration” or “individual cation concentration” means any cation (such as Na⁺, K⁺, Ca⁺⁺, Mg⁺⁺) concentration excluding hydrogen ion concentration. “Total anion concentration” or “individual anion concentration” means any anion (such as Cl⁻, F⁻, SO₄⁻², PO₄⁻³) concentration excluding hydroxyl ion concentration. Ion concentrations may be determined using techniques known in the art, such as for example, inductive coupled plasma atomic emission spectroscopy for selected cations and ion chromatography for selected anions.

In an important aspect, the aqueous feed solution to be treated with ED may have a total cation or total anion concentration of about 0.002N to about 1.0N which is effective for providing an initial conductivity of about 1.0 to about 30 mS/cm. For example, the aqueous solution to be treated with ED may include at least one of the following:

| | Concentration (N) |
|---|---|
| Cations: | |
| calcium | 0-0.2 |
| magnesium | 0-0.002 |
| potassium | 0-0.01 |
| sodium | 0-1.7 |
| Anions: | |
| bicarbonate | 0-0.07 |
| chloride | 0-1.7 |
| sulfate | 0-0.01 |

All ion concentrations can not be zero as the total ion concentration must be about 0.002N to about 1.0N. Other non-toxic, edible ions may also be included.

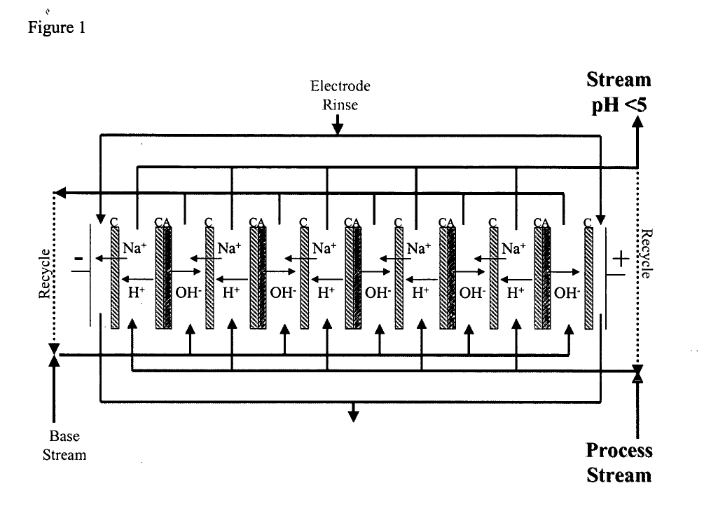

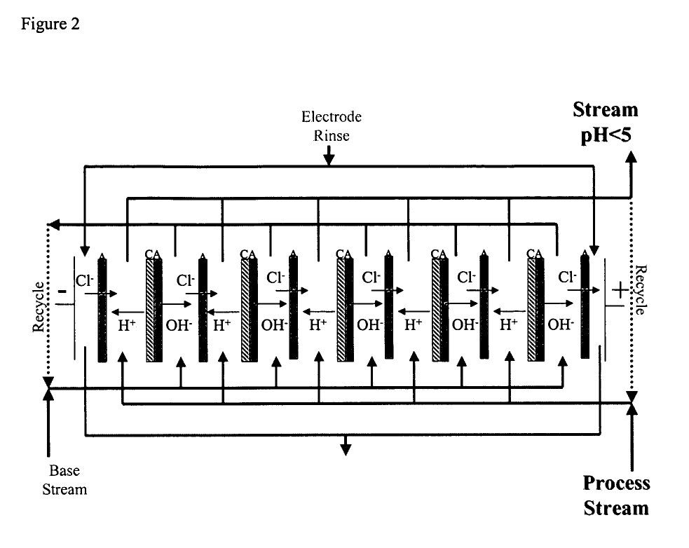

Membrane Electrodialysis. As shown in FIGS. 1 and 2, membrane electrodialysis may be conducted using a bipolar membrane and anionic or cationic membranes. The membranes are disposed between a cathode and anode and subjected to an electrical field. The membranes form separate compartments and materials flowing through those compartments may be collected separately. An example of an electrodialysis apparatus containing ion-selective membranes is EUR6 (available from Eurodia Industrie, Wissous, France). Suitable membranes are available, for example, from Tokuyama (Japan). A bipolar membrane includes a cationic membrane and an anionic membrane joined together.

In accordance with one aspect, an aqueous solution is contacted with the ion-selective membranes. Aqueous solutions may be processed in a batch mode, semi-continuous mode, or continuous mode by flowing an aqueous solution over the ion-selective membranes. An electrical potential is applied across the anode and cathode for a time effective for providing an electrodialyzed solution with the desired pH and ion concentrations. Processing times in batch mode and flow rates in semi-continuous mode or continuous mode are a function of the number of ion-selective membranes that are used and the amount of electrical potential applied. Hence, resulting ED solutions can be monitored and further processed until a desired pH and ion concentration is achieved. Generally, an electrical potential of about 0.1 to about 10 volts is provided across the anode and cathode electrode in each cell.

As shown in FIGS. 1 and 2, the pH of the aqueous solution may be adjusted to a pH range of about 0 to about 7 by contacting the aqueous solution with at least one, preferably a plurality of bipolar membranes that includes cationic membranes on both sides of the bipolar membrane. Materials from the compartments to the left of the bipolar membranes are collected for subsequent use. Materials collected from the compartments to the right of the bipolar membranes may be recirculated back through the membranes or circulated to a second membrane electrodialysis as many times as needed to provide an aqueous solution having a pH of about 0 to about 7, preferably, about 1 to about 5. Materials from the compartments to the left of the bipolar membranes may also be recirculated back through the membranes. Materials from the compartments adjacent to the anode and cathode may be recirculated back through the membranes.

Electrodialyzed Composition. After treatment with membrane electrodialysis, the pH altered ED composition has a total cation or anion concentration of less than about 1.0N, a concentration of any individual ion of less than about 0.6N and a free chlorine content of less than 2 ppm. In a preferred embodiment, the ED composition has a total cation concentration or anion concentration of less than about 0.5N, individual cation or anion concentration of less than 0.3N, and a free chlorine content of less than 1 ppm. For example, the electrodialyzed composition may contain at least one of the following:

| | Concentration (N) |
|---|---|
| Cations: | |
| calcium | 0-0.1 |
| magnesium | 0-0.001 |
| potassium | 0-0.005 |
| sodium | 0-0.9 |
| Anions: | |
| bicarbonate | 0-0.04 |
| chloride | 0-0.9 |
| sulfate | 0-0.005 |

Other non-toxic, edible ions may also present limited mainly by the taste impact of the individual ions.

After treatment with membrane electrodialysis, ED compositions will have a pH ranging from about 1 to about 5. Treated solutions have a free chlorine content of less than 1 ppm and do not have objectionable tastes and/or odors.

Preparation of Shelf-Stable Foodstuffs. In another important aspect, the ED composition, an edible inorganic acid or mixtures thereof is useful for the preservation of formulated foods. More specifically, the ED composition may be formulated into a food product by complete or partial substitution for the water normally present in the formula. Shelf stable formulated food products such as sauces, gravies, spreads, dips, dressings, salads, vegetables, starches (rice, potato, pasta, noodles, etc.), meats, seafoods, cereals, baked goods, bakery fillings, confectionary fillings, beverages, desserts, snacks and mixtures thereof in multicomponent products, are prepared by direct incorporating an amount of ED composition of predetermined pH, inorganic acid or mixtures thereof into a food formula effective for obtaining an acidified food product, wherein the amount is sufficient to achieve a final product pH of less than about 4.6 and preferably less than about 4.2.

In an optional aspect, the acidified food product is then placed in a heat-stable, sealable container. The container is sealed followed by thermally treating the food product in the sealed container at a temperature and for a time effective to pasteurize the food product. The required pasteurization step may be achieved by a simple hot fill of the acidified food product into the container. Cooling of the thermally treated food product to reduce the temperature to below about 25° C. is generally desirable. The preserved food products have no objectionable sour taste or off-flavors commonly associated with the use of food acidulants and are stable under ambient conditions for at least 6 months but generally in the order of 9 to 12 months (i.e., organic acids).

Generally, shelf-stable foodstuffs are prepared using ED compositions having a pH of about 1.0 to about 3.0. The ED composition may be incorporated into the preparation of the food itself or the ED composition may be used in the cooking of the foodstuff. Small amount of conventional food acidulant(s) such as vinegar, may still be used mainly for flavor and/or taste purposes as long as the total organic acid content does not exceed 0.12 moles per 1000 grams of final food products and preferably below 0.04 moles per 1000-gram product. For foodstuffs normally expected to be sour (e.g. cultured dairy products, fruit flavored products), the sourness of these foodstuffs after further acidified to a pH of 4.3 or less can be significantly reduced by completely or partially acidified the foodstuffs using ED composition, inorganic acid or mixture thereof as long as the total organic acid content in finished foodstuffs can be kept below 0.22 moles per 1000 grams of the finished foodstuffs.

As salt or sodium content is no long a factor in ensuring shelf stability in a low pH (e.g. 4.2 or less) and heat processed (e.g. pasteurized) product, any level of sodium reduction is possible (e.g. salt-free, lightly salted). Thus, present invention can also be used to provide nutritionally improved products.

Preparation of Shelf-Stable Dairy Products. Shelf-stable dairy products may be prepared by blending about 2 to about 12 weight percent whey protein concentrate powder with an ED composition in an amount to provide a pH of 4.3 or less, preferably 3.5 or less. Any dry or liquid sweet whey protein concentrates derived from sweet whey may be used (for example FDA53 from First District, MN.). Whey protein concentrates or isolates with low organic acid content are most preferred. Dry whey protein concentrates are commercially available at a variety of protein contents. When dry whey protein powder is used, powder are first gently mixed with warm water (about 30 to 50° C.) with only gentle agitation (Groen Kettle) to avoid aeration. Additional mixing or shearing can be used as needed to fully solubilize whey protein to form a whey protein solution.

If a final product contains liquid oil, portion of the oil from final product formula may be added to the whey protein slurry to minimize foaming. Optionally, a selected defoaming agent (for example, Trans-220K, Trans-Chemco, Inc. WI) may be used. Whey protein solution is texturized by heating to a temperature at about 180 to 205° F. and holding a time for about 5 to 20 minutes. Thick, gel-like, texturized whey protein slurry is formed during heating and can be used directly or as a dairy protein ingredient to be incorporated into food product. This texturized whey protein slurry is physically stable (without the risk of precipitating) in low pH food products and can be readily used as-is or further neutralized to a target pH (e.g. pH=4.0) generally to a higher pH than its as-is pH by blending in untexturized whey protein and/or other food ingredients generally of high pH. In less preferred cases, edible base (e.g. sodium hydroxide) may be added for pH standardization prior to subsequent preparation of low pH, shelf stable, dairy products.

While similar sauces maybe made by substituting whey protein isolate (WPI) with a commercial whey protein concentrate (WPC) at equal protein content in finished sauce, a substantially sourer and less acceptable sauce was obtained. This is apparently due to the high level of organic acids (mainly citrate and phosphate) in the WPC. In contrast, such organic acids have typically been removed during WPI production. Similarly, while another cheese flavor with added lactic acid and phosphoric acid was used, the resulting sauce became sourer and less acceptable.

Preparation of Shelf-Stable Fish. Fresh fish, particularly those having high protease activity, may be contacted with ED compositions, inorganic acids, or mixtures thereof in an amount effective for providing a pH of 4.5 or less, preferably 4.0 or less. Examples of fish that may be processed include Arrowtooth flounder, Pacific whiting, Menhaden, Sardien, Threadfin, Tuna and the like. Fish may be contacted with ED compositions and/or inorganic acids by infusion and/or injection. Infusion may be done by, for example, submerging fish fillets in an acidic solution and applying vacuum (5 minutes on followed by 30 seconds off) for a time of about 30 minutes to allow sufficient penetration of the solution into the fillets. Injection is carried out by using a multiple needles injector to inject about an amount of 10 to 20 weight percent acidic solution based on the weight of fish fillet directly into each fillet.

Preparation of Cream Cheese. A shelf stable cream cheese, cream cheese product or dairy product is highly desirable for global emerging markets in which refrigeration distribution is lacking or non-existent. The pH for a typical cream cheese product is around pH 4.7 to 5.0, which requires refrigeration storage to ensure a minimum of 5 months of shelf life. Further lowering of pH (e.g. below 4.6) via fermentation increasingly resulted in perceived sourness intensity due to lactic acid formation. For cream cheese, certain level of sourness are tolerated and often required for typical flavor profile of such products (i.e. fermented). However, the product becomes unacceptably sour in taste when product pH falls below about 4.3. Therefore, a low pH (4.3 or less) cream cheese, cream cheese-like product or dairy products with reduced sourness is desirable. Although truly shelf stable real cream cheese does not exist, prior art in attempt of manufacturing ambient stable cream cheese snack product has taken approaches mainly by keeping the product pH below 4.6 and by using preservatives including humectants (e.g. glycerol) to control the Aw to below about 0.9. Although, these approaches can improve product safety against food-born pathogens, they often render the products in poor flavor, taste (particularly objectionable sourness and off-taste from polyols), texture and/or stability. In addition, these approaches typically require the use of already made cream cheese typically about 50% of the finished product by weight as starting material. This requires additional handling and processing steps to prepare final acidified product, thus is difficult to be adapted to existing cream cheese process. Present invention not only significantly mitigates the sourness problem by selective use of pH-lowering agent(s), particularly those with little or no sourness impact but also provides a high quality, real cream cheese/dairy composition made truly (ambient) shelf-stable using normal cream cheese process. Furthermore, the present invention also represents an improved firmness and physical stability (against emulsion breakdown, syneresis, etc.) of cream cheese at ambient storage temperature by adjusting the stabilizer system without sacrificing creamy mouthfeel or developing objectionable pasty or gummy texture. Unlike prior art, the present invention may be made to comply with the U.S. standard of identity for cream cheese.

In one aspect, a high quality, high moisture (e.g. Aw>0.9), shelf stable cream cheese or dairy composition that includes, but not limited to, cream cheese, dairy spreads/dips, dairy desserts and dairy beverages is provided. For example, a shelf stable cream cheese or cream cheese product is made directly with a conventional cream cheese process having a final product pH of 4.3 or less, preferably about 4.2 or less without inducing the objectionable sour taste commonly associated with the low pH of such products. The inventive product is substantially free from syneresis (e.g. less than 2% after 6 months at ambient temperature) and has a creamy texture with a yield stress of at least 500 pascals at room temperature, preferably 1,000 to 2,000 pascals and is microbiologically stable under ambient storage conditions without the need for chemical and/or biological preservatives and/or Aw-lowering humectants (e.g. polyols). To prepare the inventive product, various manufacturing processes known to the art may be used. These applicable processes included, but not limited to, conventional curd process and future-state wheyless process. For example, the former involves first fermenting a dairy mixture to a pH of about 4.6 or higher, preferably 4.9 or higher to generate sufficient cream cheese or cultured dairy flavors and followed by additional and direct acidification using a food-grade acid(s), preferably low sourness acids (such as hydrochloric acid, sulfuric acid), their metal acid salts, low pH electrodialyzed (ED) aqueous composition, and their combination thereof to obtain a final product pH of less than 4.3. If cultured dairy flavor is not needed, culturing step may be omitted and direct acidification is used. A final heat/ pasteurization step is required to ensure shelf stability. Any edible acids or their edible acid salts and any combinations of the fore-mentioned pH-lowering agents may be used in the present invention as long as the target pH (<4.3) and a desirable level of sourness and flavor profile are achieved, preferably approved food-grade acid(s) such as hydrochloric acid and food grade acid salt(s) such as sodium bisulfate, as well as non-sour-tasting ED composition, are used as primary pH lowering agents in the present invention. Metal acid salts used in this invention include, but not limited to, sodium, potassium, calcium and magnesium salts of sulfate, phosphate, pyrophosphate, polyphosphate. The desirable sourness at a target product pH is carefully achieved by controlling the ratio of non-sour-tasting pH-lowering agents (e.g. hydrochloric acid) and sour-tasting food acids (e.g. lactic acids) in the final preserved product. Other edible sour tasting acids other than lactic acid can also be used in this invention as a flavor modifier include, but not limited to, adipic acid, citric acid, fumaric acid, gluconic acid, lactic acid, lactobionic acid, malic acid, phosphoric acid and tartaric acid. The approach and method of making the inventive products can also be used to extend the shelf life of refrigerated dairy compositions such as cream cheese (pH around 4.7 to 5.0) by further lowering the product pH (e.g. to below 4.6) using a non-sour-tasting, pH-lowering agent. The inventive product is further characterized by selective use of stabilizer system, taste modifiers and natural and/or artificial flavors for a balanced cream cheese flavor profile and an acceptable firmness/physical stability. At least one (or a combination of more than one) anionic stabilizer gum is used at a total level of 0.1% or higher. These anionic gums include, but not limited to xanthan, carrageenan, pectin and agar. Optionally, natural and/or artificial flavors and a food-grade antioxidant such as Vitamin E/EDTA can be added to improve overall flavor profile and stability.

Milk and Dairy Based Products. Products made from fresh or real milk are highly valued by consumers worldwide. Current high milk based snacks are typically low in convenience and portability (e.g. ice cream sandwich) and/or high in preservatives (e.g. salt, sugar, humactents, antimycotics). A shelf stable, high moisture, milk or dairy based snacks is highly desirable for global emerging markets in which refrigeration and/or frozen distribution are lacking or non-existent. Potentially, high moisture also enables higher product quality (e.g. creamy texture) and lower formula cost. The present invention is particularly applicable if ‘made with fresh milk’ claim is desirable. Lowering of pH through fermentation, novel acidification and their combination provide product safety with the ability to control and deliver desirable sourness intensity in most food products; even at a pH below about 4.3. The present invention uses and expands the novel acidification and preservation technology to create shelf stable snacks, particularly, multi-phase snacks with the dominant phase being high moisture, creamy, milk/dairy based component with desirable organoleptic quality and necessary handling/processing characteristics (e.g. for forming and shaping). Products provided desirable properties which include very high moisture (Aw>>0.9), high milk (or milk solid), high quality, good processability and shelf stability (even under ambient storage conditions).

Creamy, shelf stable, high moisture, milk or dairy based food product or snacks are provided. The snack has a milk or dairy containing component alone or, in a multi-phase product, as a major portion thereof enclosed, sandwiched, etc. by a minor portion(s) made of cereal (e.g. cookies), confection (e.g. chocolate), etc. The milk/dairy component has a moisture content of at least about 45 percent by weight, a water activity of at least about 0.90, a pH of less than about 4.6, preferably about 4.2 or less and comprises mainly milk (fluid/dried, fresh/concentrated, etc.) and milk derivatives (whey, whey protein concentrate, whey protein isolate, caseinate, cheese curd, butter, butter milk, cream, milk fat, etc.), thermally treated and acidified with ED composition, inorganic acid, or mixtures thereof. The said milk/dairy component also contains at least one hydrocolloid stabilizer (e.g. gelatin, carrageenan) to provide desirable processability (e.g. shaping). Optionally, flavorants, colorants, minerals, nutrients and/or other functional ingredients may be added. The milk/dairy component is prepared by mixing, pasteurizing and homogenizing a dairy mixture with optional fermentation step thereafter, and acidifying, heating, homogenizing, aerating (optional) and filling/forming it into a suitable mould/shape upon cooling. Control atmosphere packaging or preservatives (e.g. potassium sorbate) may also be used for mold and yeast control. In a multi-phase product, the minor portion, typically a lipid-continuous-phase coating (e.g. chocolate) or a baked cereal product (e.g. cookies) optionally coated with a lipid containing coating is applied. The pH of the minor components should be about 5.0 or less, and more preferably match the pH of the major component (eg. milk or dairy filing). The snack has low sourness and is safe and stable for at least about 30 days or longer (for example, four months under refrigerated storage conditions).

### EXAMPLE 1

### Shelf Stable Pasta Acidified with Hydrochloric Acid

One part of dry pasta (Rotini) was first placed in a heat stable, heat sealable pouch. A 1.4 parts of hot (about 80 C) HCl solution of pH 1.7, 1.65, 1.6 and 1.55 were added to each pouch containing dry pasta. The pouch was sealed and further cooked for about 12 minutes in water at about 95 to 100° C. The final pHs of cooked pasta were 4.3, 4.1, 3.9 and 3.2, respectively. None of the products exhibited unacceptable sour taste with total organic content below 0.04 moles per 1000-gram cooked pasta.

### EXAMPLE 2

### Low Sodium, Shelf Stable, Cheese Flavored Sauce Acidified with ED Composition

A low pH, shelf stable, protein-based, cheese flavored sauce was made with the following formula:

| | |
|---|---|
| 5.5% | whey protein isolate (80% protein) |
| 43.5% | ED Composition (standardized to acidifying |
| | power as 0.1N HCl) |
| 1.6% | krafen (a commercial sweet whey powder) |
| 0.2% | granular sugar |
| 0.2% | salt |
| 4% | corn syrup solid |
| 0.2% | gums (xanthan & carob gum) |
| 0.12% | Titanium dioxide |
| 0.17% | cheese flavor |
| 0.48% | Emulsifier (Emplex) |
| 0.09% | color(s) |
| 7.8% | vegetable (canola) oil |
| 36.14% | tap water |

Whey protein isolate was added to the ED composition and cooked to above 180° F. for 5 to 15 minutes or until thick. Pre-blended dry ingredients and oil based ingredients were added separately. Small amounts of oil were added to reduce foam. All other ingredients were then mixed into the cooked acidified whey protein slurry, and heated to above 165 F for 2 minutes. Small amount of starch could be added to thicken up the sauce, if needed. The hot cheese sauce was then passed through a homogenizer at 1200 psi, filled into glass jars or plastic pouches, and then cooled to room temperature. This yielded a smooth cheese flavored sauce with pH around 4.0 with no objectionable sourness.

A similar sauce made by substituting whey protein isolate (WPI) with a commercial whey protein concentrate (WPC) at equal protein content in finished sauce, had a substantially sourer and less acceptable. This is apparently due to the high level of organic acids (mainly citrate and phosphoric acid) in the WPC. In contrast, such organic acids have typically been removed during WPI production. Similarly, another cheese flavor sauce with added lactic acid and phosphoric acid in replacement of ED composition was prepared. The resulting sauce became very sour and totally unacceptable.

### EXAMPLE 3

### Lightly Salted Shelf Stable Sauce Acidified with Sodium Bisulfate

Based on the formula shown below, a low pH, shelf stable, starch based cheese flavored sauce was prepared by pre-blending emulsifier (Emplex) with oil based ingredients including colorants & flavors. All the remaining dry ingredients were blended with water and sodium acid sulfate solution (1.38% in tap water) in a high shear mixer. Preblended oil based ingredients were added and mixed well. The mixture was transferred to a steam-jacketed kettle and cook with constant agitation to 185° F. The sauce was homogenized at 500 and 2000 psi and filled into jars. A high quality (creamy texture, non-sour-tasting), shelf stable (pH=3.62), high moisture (71%), low sodium (750 mg or 50% reduced) cheese flavored sauce was obtained. The finished product was shelf stable under ambient storage conditions with excellent quality and 50% reduced sodium as compared to a typical shelf stable cheese sauce that is preserved mainly by high salt content.

Cheese Flavored Sauce Formulation

| | |
|---|---|
| 56% | Water |
| 15.3% | Sodium Acid Sulfate Solution |
| 11% | Bulking agents |
| 9% | Butterfat or oil |
| 4.75% | Starch |
| 1.25% | Cheese powder(s) |
| 1.3% | Salt |
| 0.5% | Emulsifier (Emplex) |
| 0.3% | Gum (xanthan & Carob gums) |
| 0.20% | Titanium dioxide |
| 0.20% | Colorants |
| 0.13% | Flavor System |

### EXAMPLE 4

### Shelf Stable Alfredo Sauce Acidified with Hydrochloric Acid

A low pH, shelf stable alfredo sauce was made with 15% ED composition (standardized to acidifying power as 0.1N HCl by standardization with 1N or 6.25N HCl) to a pH of 1.0, 3.7% starch, 10% corn syrup solid, 0.7% salt, 0.2% titanium dioxide, 0.5% emulsifier, 0.2% gums, 0.04% flavor, 6.4% butter, 2.7% vegetable oil, 0.1% spices, 1.25% cheese powder, and the remainder of normal tap water. Dry and oil based ingredients were pre-blended separately. All ingredients were mixed with a high shear mixer. The sauce was cooked to 180° F. for 2 minutes or until thick. The hot sauce was then passed through a homogenizer at 1200 psi, filled into glass jars or plastic pouches, and then cooled to room temperature. This yielded a shelf stable, smooth, creamy Alfredo sauce with pH around 4.1 with no objectionable sourness and very low sodium content.

### EXAMPLE 5

### Shelf Stable Texturized Dairy Base Acidified with ED Composition and Chocolate Flavored Drinks Prepared Therefrom

A low pH, shelf stable, texturized whey protein concentrate (tWPC) slurry was prepared by heating a commercial WPC (FDA 53 from First District, MN) solution of ED composition at a pH of 3.35 to 3.5 to about 185° F. and holding for about 5 minutes. The rest of ingredients were added and the mixture was heated (to about 185° F.) and homogenized with a lab, high shear mixer (Tekmar) for about one minute. Taste results indicated expected creamy texture but unacceptable taste (exceeding sourness). The origin of the sour taste was further investigated by comparing the following 4 samples with 15% surcose and a pH of 4.19: (1) 2.85% cocoa powder (D11-S); (2) 6.65% Krafen, (3) 2.85% D11-S and 6.65% Krafen; and (4) 2.85% D11-S, 6.65% Karfen and 0.16% vanilla extract. Taste results confirmed that the perceived sour taste comes from both dairy ingredients and cocoa powder (a fermented ingredient naturally rich in organic acids. The increased level of whey protein concentrate (FDA53) also significantly contributed to the perceived sour taste.

| Ingredient | Weight % |
|---|---|
| Sucrose | 18.0 |
| FDA53 from tWPC | 4.9 |
| Palm Kernel Oil | 4.6 |
| Cocoa Powder (D11S) | 2.85 |
| Emulsifier (Emplex) | 0.2 |
| Vanilla Extract | 0.16 |
| TiO2 | 0.12 |
| ED Composition | 16.1 |
| DI water | 53.1 |

### EXAMPLE 6

### Improved Chocolate Flavored Dairy Drink

A low pH, shelf stable, chocolate drink was prepared by replacing (as relating to Example 5) high-citrate and high-phosphate WP50 with WPC80 (from Leprino) and by replacing cocoa powder (D11S) with natural cocoa flavor, natural colors and a bitter compounds (naringen). A thick slurry of tWPC was prepared by heating a WPC80 solution of ED water at a pH of 3.35 to 3.5, except that WPC80 is used to replace FDA53. Preparation method used for chocolate flavored drink was the same as in EXAMPLE 5. A less sour drink (than Example 5) was obtained due to the lowered organic acid content in the finished drink. A slightly citrus-like flavor was detected from niringen, a bitter compound form citrus.

| Ingredient | Weight % |
|---|---|
| Sucrose | 12.5 |
| WPC80 | 3.15 |
| Palm Kernel Oil | 2.0 |
| Emulsifier (Emplex) | 0.12 |
| Flavor 7887-25 | 0.12 |
| Caramel color (BC 420) | 1.21 |
| Cochineal Extract AP blend | 0.48 |
| (natural color extract) | |
| ED composition (pH 1.0) | 12.50 |
| DI water | 68.69 |
| Naringen | 0.005 |

### EXAMPLE 7

### Further Improved Chocolate Flavored Dairy Drink

A low pH, shelf stable, chocolate drink was prepared by replacing WPC80 (from Leprino) with WPI (BiPro) and by replacing cocoa powder with cocoa flavor. Slightly different natural and artificial colors and a bitter compound from cocoa (theobromine) were used. Thick slurry of tWPC was prepared by heating a WPI solution of ED water at a pH of about 3.5. The preparation method used for chocolate flavored drink was the same as in EXAMPLE 5. Since WPI contains high protein and less ash (and citrate and phosphate) than WPC80, the resulting drink was essentially non-sour and highly acceptable in taste. This example and along with EXAMPLE 5 and 6 demonstrates that sour-tasting organic acids including their metal salts (e.g. calcium citrate) in soluble form are responsible for perceived sourness at low pH. The progression of sourness reduction from Examples 5 to 7 was demonstrated by minimizing organic acid content in the finished drinks by replacing high organic acid ingredients (eg. D11S with chocolate flavor and color whey powder, with WPC50, with WPC80, and then with whey protein isolate/BiPro. By controlling the total organic acids in finished food products effectively reduces and/or eliminates unwanted sour taste.

| Ingredient | Weight % |
|---|---|
| Sucrose | 12.5 |
| WPI | 1.30 |
| AMF | 1.14 |
| Emplex | 0.06 |
| Xanthan | 0.18 |
| Flavor 7887-25 | 0.12 |
| Salt | 0.12 |
| Caramel color (BC 420) | 1.10 |
| Red 40 (0.1% solution) | 1.90 |
| TiO2 | 0.12 |
| Theobromine | 0.02 |
| ED water (pH 1.0) | 5.41 |
| DI water | 75.90 |

### EXAMPLE 8

### Effects of Acidification Methods And Total Organic Acid Content on Shelf Stable Cheese Flavored Sauces

Two low pH, shelf stable, protein based cheese sauces were prepared according to the method of Example 2 to demonstrate the effect on the perceived sourness intensity due to acidification method by comparing lactic acid and ED compositions as sole acidifying agents, respectively. A third sample (Sample 3) was also made having identical gross composition and using the same formula as Sample 2 (with ED composition), except that FDA-53, a commercial whey protein concentrate from FDA was replaced with BiPro, a whey protein isolate from Danisco. BiPro has significant lower level of lactate, citrate and phosphate. This sample (Sample 3) allows the quantification of the combined effect on sourness due to ingredient (FDA-53 vs Bipro) and acidification technology (conventional lactic acid vs. ED composition). All 3 samples were evaluated by a 7-member, trained sensory panel for relative sourness using a 15-point scale. The sensor data indicated significant difference among the 3 samples. Sample 1 was about 2.3× and 4.8× sourer than Sample 2 and Sample 3, respectively. Sample 1 is about 2.3× and 4.8× sourer than Sample 3. It is clear that (1) use of ED compositions is superior to conventional acidification (Sample 1) and (2) mere use of non-sour tasting acidification method (Sample 2) may not be sufficient for formulated foods containing certain ingredients (e.g. FDA-53) that are high in organic acids and their salts. Thus, according to the present invention, the total organic acids (including their salts) in a shelf stable, low pH formulated foods must be kept below about 0.12 moles per 1000 grams (preferably below 0.6 moles per 100 grams) to ensure the absence of objectionable high sourness. Based on chromatographic analysis, Sample 1 has a total organic acid 2.3× and 7.3× higher than that of Sample 2 and Sample 3, respectively.

| | SAMPLE 2 | | | SAMPLE 1 | | |
|---|---|---|---|---|---|---|
| | ED Composition | | | Lactic Acid | | |
| Ingredient | % | Gram | Lbs | % | gram | Lbs |
| ED Water (0.1 AP) | 46.50% | 10546.20 | 23.250 | | | |
| Diluted 88% Lactic | | | | 3.50% | 793.80 | 1.750 |
| Acid*¹ | | | | | | |
| Water | 10.26% | 2326.51 | 5.129 | 64.26% | 14573.71 | 32.129 |
| FDA 53 | 9.00% | 2041.20 | 4.500 | 9.00% | 2041.20 | 4.500 |
| Rezista Starch | 3.00% | 680.40 | 1.500 | 3.00% | 680.40 | 1.500 |
| Sharpee | 1.25% | 283.50 | 0.625 | 1.25% | 283.50 | 0.625 |
| (uncolored) | | | | | | |
| Krafen | 1.60% | 362.88 | 0.800 | 1.60% | 362.88 | 0.800 |
| Sugar | 0.30% | 68.04 | 0.150 | 0.30% | 68.04 | 0.150 |
| Salt | 0.20% | 45.36 | 0.100 | 0.20% | 45.36 | 0.100 |
| Frodex-24 | 4.00% | 907.20 | 2.000 | 4.00% | 907.20 | 2.000 |
| Locust Bean Gum | 0.17% | 39.01 | 0.086 | 0.17% | 39.01 | 0.086 |
| Xanthan Gum | 0.05% | 11.79 | 0.026 | 0.05% | 11.79 | 0.026 |
| Titanium Dioxide | 0.12% | 27.22 | 0.060 | 0.12% | 27.22 | 0.060 |
| Kraft Flavor #18 | 0.14% | 32.66 | 0.072 | 0.14% | 32.66 | 0.072 |
| CT3 Flavor | 0.03% | 6.35 | 0.014 | 0.03% | 6.35 | 0.014 |
| Emplex | 0.48% | 108.86 | 0.240 | 0.48% | 108.86 | 0.240 |
| Annatto Oil | 0.07% | 16.33 | 0.036 | 0.07% | 16.33 | 0.036 |
| Oleoresin Paprika | 0.02% | 5.44 | 0.012 | 0.02% | 5.44 | 0.012 |
| Anydrous Milkfat | 8.80% | 1995.84 | 4.400 | 8.80% | 1995.84 | 4.400 |
| Holding for pH | | | | | | |
| Adjustment | | | | | | |
| ED Water (0.1 AP) | 2.00% | 453.60 | 1.000 | | | |
| Diluted 88% Lactic | | | | 1.00% | 226.80 | 0.500 |
| Acid | | | | | | |
| Water | 12.00% | 2721.60 | 6.000 | 2.00% | 453.60 | 1.000 |
| Totals | 100.00% | 22680.00 | 50.000 | 100.00% | 22680.00 | 50.000 |

### EXAMPLE 9

### Comparison Sensory Sourness in Acidified Chocolate Flavored Drinks

Additional low pH, shelf stable chocolate flavored dairy drinks were prepared to demonstrate superior quality (e.g. reduced sour taste) over a conventionally acidified (with lactic acid) cocoa drink (control). The inventive samples were prepared according to the formulas and procedures outlined below. The inventive chocolate flavored drink was identical to that described in Example 8. The control sample was prepared by reconstituting (Baker's, Kraft Foods) hot cocoa drink powder according to the package instructions. Twenty eight (28) grams of mix was placed into a container. Hot water (870 g) was added and stirred well. The mixture was cooled to room temperature and then titrated with 88% lactic acid to a final pH of 4.1. The two samples had the same gross composition in fat, protein, sugar and moisture content.

A formally trained 7-member sensory panel evaluated both samples and the inventive sample was judged to be significantly less sour (2.5×) than the control. The inventive product also exhibited a desirable, creamy, smooth, rich mouthfeel atypical to a dairy product at pH 4.1. This example further demonstrates that high organic acid containing ingredients in the control cocoa drink such as cocoa powder (a fermented ingredient) and whey powder (high in lactic, citric and phosphoric acid) contribute to perceived sourness. And, by eliminating these ingredients, an acceptable product with significantly lower soumess can be produced. The inventive example also demonstrates that (1) an acidic chocolate flavored product is possible and (2) by lowering the product pH below 4.2, a simple hot fill treatment can be used to replace expensive retort process required for shelf stable dairy product with potential quality/nutrition improvement due to reduced thermal degradation.

### EXAMPLE 10

### Shelf Stable, Low pH Dairy Base

A shelf stable, low pH (<4.2), bland dairy base was prepared. About 1 part of whey protein concentrate (FDA53) was combined with about 3 parts of EWA1.1 (ED composition at pH of about 1.1) in a jacket kettle; mixed to fold in FDA53 powder first, then sheared with Tekmar to fully disperse FDA53. Check to make sure the pH of the slurry is about 3.5. Adjust pH, if necessary, with additional EWA1.1, but to maintain a ratio of FDA53 to total moisture at 1 to about 3. Add a small amount (less than about 0.5 part) of melted palm kernel oil (PKO) to FDA53 slurry to prevent foaming. Heat with gentle mixing to about 200 F and hold for additional 12 mins at 200° F. to texturize. Pour the hot mixture into a container. Seal the filled container. Optionally, store in refrigerator after cooling to RT. The final texturized WPC (tWPC) is semi-translucent and thick (or gel-like). Importantly, the said texture system has low sourness intensity and a smooth texture at pH<4.2.

### EXAMPLE 11

### Shelf Stable Unflavored Dairy Base

A shelf stable, acidic (pH=4.1) sweet, unflavored dairy base was prepared according to the following procedure.

| Ingredient | % |
|---|---|
| tWPC | 60.00 |
| DI water | 18.20 |
| FDA53 | 3.00 |
| Sucrose | 17.00 |
| LBG | 0.20 |
| XG | 0.05 |
| Emplex | 0.30 |
| PKO | 1.10 |
| TiO2 | 0.15 |
| Total | 100.00 |

All dry ingredients were pre-blended together except for Emplex. PKO was pre-blended with Emplex and heated to disperse. In a jacketed kettle, tWPC was mixed with water, PKO/Emplex and dry blend. The pH was standardized to about 4.10 to 4.15 with additional FDA53. Homogenization was conducted with Tekmar before and during pH adjustment. The balance of the formula weight was made up with DI water. The mixture was conducted with gentle mixing to about 175 to 185 F and held for about 2 mins. Homogenization was conducted at 5000/1000 psi. The final mixture was then filled into containers and immediately sealed in the container. Optionally, samples may be stored in refrigerator after cooling to room temperature. Most importantly, the final base has an unusual creamy texture and an acceptable level of sour taste at a pH of less than 4.2.

### EXAMPLE 12

### Preparation of Fish Filets

Pacific arrowhead flounder fillets were submerged in a series of aqueous solutions and under vacuum effective to obtain about 20% weight gain. The infusion solutions used and final pH of the infused fish fillets are given in the table below. The infusion was done under vacuum (5 minutes on/30 seconds off) for 30 minutes. Treated fish fillets were cooked in a two-stage cooking process by first cooking at about 60 C for about 30 minutes, and then further cooking the fish at about 90 C for about 30 minutes.

| Infusion Solution | Solution pH | pH of Infused Fillets |
|---|---|---|
| Distilled H₂O (A) | 6.8 | 7.1 |
| ED composition (B) | 1.2 | 5.0 |
| 0.20N HCl | 0.92 | 4.8 |
| 0.25N HCl | 1.04 | 4.08 |
| 0.5N HCl | 0.85 | 2.94 |
| 1N HCl (C) | 0.67 | 1.53 |

The results clearly demonstrate that the infused fish fillets with ED composition (Sample A) and 1N hydrochloric acid solution (Sample B) clearly exhibited superior muscle structure integrity and firm/ flaky texture over the distilled water control (Sample C). All infused fillets are free from unpleasant off-flavors or objectionable sourness.

### EXAMPLE 13

### Shelf Stable Cream Cheese

Full fat 30# block cream cheese at 33% fat, and pilot-plant-made reduced fat cream cheese at 18% fat were used to prepare three different sets of low pH (target pH 4.15) cream cheese in lab. The pH adjustment was made with either lactic acid or HCl before mix heating and homogenization. The control sample had normal pH (about 7.0) without additional pH adjustment. Preparation procedures were as follows.
1. Melt cream cheese ( 1200 gms/each variable) in Stephan cooker.
2. Measure the temperature (˜100° F.),
3. Adjust pH at this lower temp. (e.g. 100° F.) until pH 4.15 using lactic acid or 6.25N HCl (This step was skipped for control).
4. Reheat cream cheese to 176° F. for 2 min.
5. Homogenize the samples @5000/500 psi.

5. Fill cream cheese into 8 oz tub.

| | | R.T. Yield | | | Sensory | Sourness |
|---|---|---|---|---|---|---|
| Sample | | Stress | | | Evaluation | Rank |
| Code | Sample ID | Pscal | pH | % Moisture | Comments | 1-least |
| #1 | Phil. FS Full Fat C.C. @ 33% fat | 914/72 F. | 4.69 | 53.26 | Creamy, Buttery | 1 |
| #2 | Phil. FS Full Fat to pH 4.15 | 1154/73 F. | 4.26 | 52.7 | Sour, less creamy, | 3 |
| | Use Lactic Acid | | | | less culture note | |
| #3 | Phil. FS Full Fat to pH 4.15 | 1758/73 F. | 4.21 | 51.8 | acceptable sour, | 2 |
| | Use 6.25N HCL | | | | less creamy | |
| #1 | Phil. Red. Fat Cream Cheese Control @ 18% fat | 600/73 F. | 4.69 | 66.9 | Sourer than full fat | 1 |
| | | | | | less creamy | |
| #2 | Phil. Skinny Lactic A. | 605.5/73 F. | 4.16 | 64.2 | very sour, lack of | 3 |
| | Use Lactic Acid | | | | buttery notes | |
| #3 | Phil Skinny 6.25N HCL | 1037/73 F. | 4.15 | 64.2 | acceptable sour, less | 2 |
| | Use 6.25 N HCL | | | | creamy | |
| #1 | Future State Light Soft CC @ 12% Fat | 737/73 F. | 4.75 | 68.9 | similar sourness to #2 | 1 |
| #2 | Olympus 6.25 N HCL + 1% Sucrose | 753/72 F. | 4.2 | 67.4 | acceptable sour, | 2 |
| | | | | | less creamy flavor | |

Sensory evaluations suggested both low pH products are more sour and are lacking a creamy note. HCl-acidified samples were overwhelmingly more preferred than lactic acid acidified samples due to lower perceived sourness.

### EXAMPLE 14

### Shelf Stable Soft Cream Cheese

Regular, commercial soft cream cheese at 28% fat was used to compare the taste effect of selected acids. While lactic acid and phosphoric acid samples were considered acceptable, taste panels preferred the HCI acidified samples. Preparation procedures were as follows.
1. Melt Cream cheese (1814 gms/each variable) in Stephan cooker.
2. Measure the temperature (˜100° F.)
3. Adjust pH at this lower temperature (i.e. 100° F.) until pH 4.15 using a designated acid (i.e. HCl, lactobionic acid, phosphoric acid, lactic acid).
4. Reheat cream cheese to 176° F. for 2 min.
5. Homogenized the sample @5000/500 psi.

6. Fill Cream cheese into 8 oz tubs.

Shelf Stable Cream Cheese
*Starting Material: Regular Soft Cream Cheese Retail 16 oz product @ 28% Fat
This lot Cream Cheese has very low yield stress --(I.e. 1397 Pa-refrig., 463 Pa-room temp)

| | #1 | #2 | #2-S w/HCL | #3 | #4 | #5 |
|---|---|---|---|---|---|---|
| | Control | w/6.25 N HCL | &.5% sucrose | w/Lactic Acid | w/Phosporic A | w/Lactobionic Acid |
| Ingredient | % | % | % | % | % | % |
| Xanthan | 0.07 | 0.07 | 0.07 | 0.07 | 0.07 | 0.07 |
| 6.25 N HCL | | 0.42 | 0.4 | | | |
| Lactic Acid | | | | 0.36 | | |
| Phosphoric Acid | | | | | 0.36 | |
| Lactobionic Acid | | | | | | 1.87 |
| Sucrose | | | 0.5 | | | |
| Cream Cheese | 99.93 | 99.51 | 99.03 | 99.57 | 99.57 | 98.06 |
| Total | 100 | 100 | 100 | 100 | 100 | 100 |
| Amt. Acid Added (gm) | 0.00 | 7.62 | 7.32 | 6.50 | 6.50 | 34.18 |
| Actual pH (Mar. 5, 2004) | 4.94 | 4.22 | 4.27 | 4.25 | 4.19 | 3.98 |
| Moisture % | 59.4 | 59.21 | 60.08 | 59.56 | 58.62 | 57.81 |
| Y.S. (Pa) - R.T.-Mar. 11, 2004 | 456 | 652 | 568 | 513 | 551 | 566 |
| Sensory Comments | creamy | creamy, sour | milky, sweet | sour, less creamy | low cream, culture | Very sour, acid bite |
| | sour, cultured | closest to #1 | cooked note | culture note | sour | |
| Sourness Rank | 1 | 2 | 3 | 4 | 5 | 6 |
| 1-Least sour | | | | | | |

Overall, the HCl-acidified sample was rated closest in sourness to the high pH control.

### EXAMPLE 15

### Shelf Stable Cream Cheese Prepared with a Wheyless Process

Acceptable shelf-stable/low pH full fat soft cream cheese at 27% fat can be made directly using a wheyless, commercially viable process without the use of pre-made cream cheese. Experimental details (procedures, formulas and results) are outlined below.
1. Pre-heat UF acid whey in Microwave to above 110 F.
2. Mix FDA-50 into the slurry by lightening mixer to make the wet mix.
3. Add warmed PKO (˜110 F) into wet mix, use turbomixer to make a coarse emulsion.
4. Add acid (i.e. 6.25 N HCL) into the system and Heat the wet mix in MW to 140 F.
5. Pass the mixture thru homogenizer at 5000/500 psi.
6. Add salt/sorbic Acid/gum, add slowly into the mixture.
7. Pour the mixture into Stephan cooker and Heat the homogenized mixture at 200° F. for 10 min.
8. Add Flavor (LNDT-5), check final temp., Check moisture and correct it with hot water.
9. Homogenize the sample using a two-stage homogenizer (5000 psi/500psi).

10. Hot fill the samples (⅔ ht.) into 8 oz tub.

| | EXP #1 | EXP #2 | EXP #3 |
|---|---|---|---|
| Weigh up (lbs) | (%) | (%) | (%) |
| AMF | 24.98 | 0.00 | 14.98 |
| PKO | | 24.98 | 10.00 |
| UF Acid Whey | 67.37 | 67.37 | 67.37 |
| FDA 53 | 5.40 | 5.40 | 5.40 |
| 6.25 N HCL | 0.40 | 0.40 | 0.40 |
| Sucrose | 0.20 | 0.20 | 0.20 |
| sorbic Acid | 0.05 | 0.05 | 0.05 |
| LNDT-5 | 0.05 | 0.05 | 0.05 |
| Carr GP 911 | 0.05 | 0.05 | 0.05 |
| Carob | 0.25 | 0.25 | 0.25 |
| Inulin | 0.50 | 0.50 | 0.50 |
| CaSO4—2H2O | 0.00 | 0.00 | 0.00 |
| Salt | 0.75 | 0.75 | 0.75 |
| Sub total | 100.00 | 100.00 | 100.00 |
| Quality | Good | Good | Good |
| Target Moisture | 60.00% | 60.00% | 60.00% |
| (%) | | | |
| pH | 4.2 | 4.2 | 4.2 |
| Yield Stress (Pa)/R.T. | 988 | 3615 | 1155 |
| Syneresis | yes | No | very |
| | | | slight |
| Yield Stress (Pa)/47 F. | 2937 | 3769 | 2621 |

Target Composition #1: 60% Moisture, 27% fat, 5.45% protein, 5.09% lactose. Acid Whey Composition: 12.1% solids, 2.75% fat, 3.7% protein, 4.3% lactose.

### EXAMPLE 16

### Shelf Stable Cream Cheese Made from Conventional 2-Day Process A low pH, shelf stable, sourness reduced cream cheese was prepared using conventional 2-day processing method:

Procedure

Day 1

Mix Making

| | Actual | Exp 1-3 | |
|---|---|---|---|
| Ingredient | (%) | (lbs) | |
| Cream | 70.64 | 318 | |
| Water | 22.4 | 100.8 | |
| WPC 53 | 6.94 | 31.2 | |
| Total | 100% | 450 | lbs |

Mix WPC 53 and with liquids in Breddo mixer.
   Mix all ingredients in Groen kettle.
   Heat kettle contents to 120° F.
   Feed mixture to microthermics.
   Set microthermics preheat to 140° F.
Add cultures with agitation
Cooled mixture will be stored in milk cans and held in cream cheese pilot plant overnight.
Allow to ferment to a pH 4.9
   Day 2

Processing

| | | Exp 1-4 | |
|---|---|---|---|
| Ingredient | % | (lbs) | |
| Curd | 98.31 | 78.57 | |
| Sorbic Acid | 0.03 | 0.02 | |
| Salt | 0.80 | 0.64 | |
| Inulin | 0.50 | 0.40 | |
| Carob | 0.25 | 0.21 | |
| Xanthan Gum | 0.10 | 0.08 | |
| Nat. Dairy FI. 8127-20 | 0.10 | 0.08 | |
| Mixed Tocopherol | 0.0075 | 0.013 | |
| MTS-90 | | | |
| Total | 100% | 80 | lbs |

Mix curd and dry ingredients in Breddo.
Transfer mixture to steam jacketed Kettle.
Adjust pH with 6.25 N HCl to 4.10+/−0.05.

The resulting sample had a pH 4.13 and a yield stress of 1,693 pascals at 73 F. Sample was judged by sensory experts to be of excellent flavor and texture, and without objectionable sour taste. While evaluated by a 7-member, trained sensory panel against a control (lactic acid to replace 6.25N HCl on day-2), this sample has similar sourness of regular higher pH (e.g. 4.7) cream cheese and is about 30% less sour than the lactic acid control.

### EXAMPLE 17

### High Moisture Milk Filling

A high moisture (>50%), low pH, shelf stable, milk filling was prepared according to the following procedure and formula.
1. Mix Whole Milk, MPC-70 using a lightening mixer.
2. Heat both the wet mix to 165° F.
3. Melt AMF and heat to 165° F.
4. Use a turbomixer to make a coarse emulsion.
5. Homogenize at 3000/500 psi
6. Add 6.25 N HCL to adjust pH to 4.4/4.2
7. Add preblend gums & Sugar into the curd.
8. Heat it in a thermomixer until 190 F. Hold for 3 min (Total 12-13 min).
9. Homogenize at 5000/500 psi.
10. Collect the sample into a bowl.
11. Store in the refrigerator for 1 hour or put in the ice bath until below 50 F temp.
12. Whip the product in a Hobart (High speed for 1 min, 2 min, 3 min).
13. Measure the bulk density.
14. Chill in a refrigerator.
15. Next day, cut into a slate as a milk filling.

### High Moisture Milk Filling

| | #2* | |
|---|---|---|
| Ingredient | % | gms |
| Whole Milk | 57.95 | 869.25 |
| MPC-70 | 10 | 150 |
| Nutrilac | | |
| AMF | 15 | 225 |
| Sugar | 13.45 | 201.75 |
| 6.25 N HCL | 2.55 | 25.45 |
| Carob | 0.4 | 6 |
| Xanthan Gum | 0.1 | 1.5 |
| Gelatin 240 bloom | 0.5 | 7.5 |
| Sorbic Acid | 0.05 | 0.75 |
| | 100 | 1500 |
| Composition | | |
| Moisture | 54.02 | |
| Fat | 17.33 | |
| Protein | 8.89 | |
| Sugar | 13.45 | |
| Lactose | 4.56 | |
| Salt | 0.24 | |
| Ash | 1.36 | |
| | 99.85 | |
| Final pH | 4.24 | |
| Filling Texture | cuttable | |
| taste/flavor | Great | |

### EXAMPLE 18

### High Moisture, Shelf Stable Milk Filling

A high moisture milk was prepared according to the following formula and procedure given in Example 17.

### High Moisture

### Milk Fillings

| Ingredient | % | g. |
|---|---|---|
| Whole Milk | 49.41 | 741.15 |
| MPC-70 | 4 | 60 |
| AMF | 30 | 450 |
| PKO | 0 | 0 |
| Sugar | 13.69 | 205.35 |
| 6.25 N HCL | 1.35 | 20.25 |
| Carob | 0.4 | 6 |
| GP911 | 0 | 0 |
| Xanthan Gum | 0.1 | 1.5 |
| Gelatin 240 | 1 | 15 |
| bloom | | |
| Sorbic Acid | 0.05 | 0.75 |
| | 100 | 1500 |
| Composition | | |
| Moisture | 45.99 | |
| Fat | 31.85 | |
| Protein | 4.47 | |
| Sugar | 13.69 | |
| Lactose | 3.1 | |
| Salt | 0.12 | |
| Ash | 0.78 | |
| | 100 | |
| starting pH | 6.63 | |
| Final pH | 4.37 | |
| Density | | |
| Texture | Best, | |
| | cuttable | |
| % Moisture | 47.26 | |

This product was judged to be superior in flavor, texture and without the objectionable sourness. Its overall quality approaches that of ice cream particularly in creaminess.

1. A method for preparing a non-sour tasting, shelf-stable, high moisture, foodstuff comprising preparing the foodstuff with acidic ED composition, an edible inorganic acid, or mixtures thereof in amount effective for providing a foodstuff with a final pH of 4.6 or less,
the foodstuff having a total organic acid content of 0.12 moles per 1000 grams of foodstuff or less.

2. The method of claim 1 wherein the foodstuff is heated to a temperature of 165° F. or greater.

3. The method of claim 1 wherein the foodstuff has an Aw of 0.85 or greater.

4. The method of claim 3 wherein the foodstuff has an Aw of 0.90 or greater.

5. The method of claim 1 wherein the foodstuff is selected from the group consisting of sauces, gravies, spreads, dips, dressings, salads, vegetables, starches, meats, sea foods, cereals, baked goods, fillings, toppings, baked goods, confection, beverages, desserts, snacks, and mixtures thereof.

6. The method of claim 1 wherein the foodstuff has a final pH of 4.3 or less.

7. The method of claim 6 wherein the foodstuff has a final pH of 4.2 or less.

8. The method of claim 1 wherein the foodstuff has a total organic acid content of 0.06 moles per 1000 grams of foodstuff or less.

9. The method of claim 1 wherein the inorganic acid is selected from the group consisting of hydrochloric acid, sulfuric acid, sodium bisulfate, potassium bisulfate, and mixtures thereof.

10. A shelf-stable, reduced sodium foodstuff prepared by a process comprising preparing the foodstuff with ED composition, an edible inorganic acid, or mixtures thereof in amount effective for providing a foodstuff with a final pH of 4.6 or less,
the foodstuff having a total organic acid content of 0.12 moles per 1000 grams of foodstuff or less.

11. The foodstuff of claim 10 wherein the foodstuff has an Aw of 0.75 or greater.

12. The foodstuff of claim 11 wherein the foodstuff has an Aw of 0.85 or greater.

13. The foodstuff of claim 10 wherein the foodstuff is selected from the group consisting of sauces, gravies, spreads, dips, dressings, salads, vegetables, starches, meats, sea foods, snacks, and mixtures thereof.

14. The foodstuff of claim 10 wherein the foodstuff has a final pH of 4.3 or less.

15. The foodstuff of claim 14 wherein the foodstuff has a final pH of 4.2 or less.

16. The foodstuff of claim 10 wherein the inorganic acid is selected from the group consisting of hydrochloric acid, sulfuric acid, sodium bisulfate, potassium bisulfate, and mixtures thereof.

17. The foodstuff of claim 10 wherein the foodstuff is heated to a temperature 165° F. or higher to pasteurize.

18. A method for preparing a shelf stable dairy product comprising blending whey protein concentrate powder with ED composition, an edible inorganic acid, or mixture thereof in an amount effective for providing a pH of 4.3 or less, the blending effective for providing a texturized whey protein base, the dairy product having a total organic acid content of 0.12 moles per 100 grams of finished dairy product or less.

19. The foodstuff of claim 18 wherein the inorganic acid is selected from the group consisting of hydrochloric acid, sulfuric acid, sodium bisulfate, potassium bisulfate, and mixtures thereof.

20. The method of claim 18 wherein 2 to 12 weight percent whey protein concentrate powder is blended with ED composition.

21. The method of claim 18 wherein whey protein concentrate powder is blended with ED composition in an amount effective for providing a pH of 3.5 or less.

22. The method of claim 18 wherein the whey protein concentrate powder ED composition blend is heated at 180 to 205° F. for 5 to 20 minutes.

23. The method of claim 18 wherein a defoaming agent is added to the whey protein concentrate powder ED composition blend prior to heating.

24. The method of claim 18 wherein additional whey protein concentrate and base are further blended with the texturized whey protein base in amounts effective for providing a pH of 4.6 or less.

25. The method of claim 24 wherein 0 to 8 weight percent of the additional whey protein concentrate is blended with the texturized whey protein base.

26. The method of claim 24 wherein the blend of additional whey protein concentrate and texturized whey protein slurry is heated at 175 F to 205° F. for at least 1 minute.

27. A shelf stable dairy product prepared by a process comprising blending whey protein concentrate powder with ED composition, inorganic acid, and mixtures thereof in an amount effective for providing a pH of 4.3 or less, the blending effective for providing a texturized whey protein base.

28. The dairy product of claim 27 wherein the inorganic acid is selected from the group consisting of hydrochloric acid, sulfuric acid, sodium bisulfate, potassium bisulfate, and mixtures thereof.

29. The dairy product of claim 27 wherein 2 to 12 weight percent whey protein concentrate powder is blended with ED composition.

30. The dairy product of claim 27 wherein whey protein concentrate powder is blended with ED composition in an amount effective for providing a pH of 3.5 or less.

31. The dairy product of claim 27 wherein the whey protein concentrate powder ED composition blend is heated at 180 to 205° F. for 5 to 20 minutes.

32. The dairy product of claim 27 wherein a defoaming agent is added to the whey protein concentrate powder ED composition blend prior to heating.

33. The method of claim 27 wherein additional whey protein concentrate and base are further blended with the texturized whey protein in amounts effective for providing a pH of 4.6 or less.

34. The dairy product of claim 33 wherein 0 to 8 weight percent of the additional whey protein concentrate is blended with the texturized whey protein base.

35. The dairy product of claim 34 wherein the blend of additional whey protein concentrate and texturized whey protein base is heated at 175 to 205° F. for at least 1 minute.

36. A method for increasing structural integrity and shelf-life of fish comprising contacting the fish with acidic ED composition, edible inorganic acid, or mixtures thereof in an amount effective for providing a pH of 4.5 or less.

37. The method of claim 36 wherein the inorganic acid is selected from the group consisting of hydrochloric acid, sulfuric acid, sodium bisulfate, potassium bisulfate, and mixtures thereof.

38. The method of claim 36 wherein the pH is 4.0 or less.

39. The method of claim 36 wherein the fish are contacted with ED composition, edible inorganic acids, or mixtures thereof by infusion or injection.

40. A method for preparing a shelf-stable cream cheese or cream cheese-like product comprising:
fermenting a dairy mixture to a pH of 4.4 or higher;
acidifying to a pH of 4.3 or lower with acidic ED composition, inorganic acid, or mixtures thereof; and
heating to a temperature of 165° F. or higher to pasteurize,
the cream cheese or cream cheese-like product having a total organic acid content of 0.22 moles or less per 1000 grams of product.

41. The method of claim 40 wherein the dairy mixture is fermented to a pH of 4.8 or higher.

42. The method of claim 40 wherein the dairy mixture is acidified to a pH of 4.2 or lower.

43. The method of claim 40 wherein the inorganic acid is selected from the group consisting of hydrochloric acid, sulfuric acid, sodium bisulfate, potassium bisulfate, and mixtures thereof.

44. The method of claim 40 wherein the dairy mixture is directly acidified without fermentation to a pH of 4.3 or less with ED composition, inorganic acid or mixture thereof.

45. The method of claim 44 wherein the dairy mixture is directly acidified without fermentation to a pH of 4.3 or less with ED composition, inorganic acid or mixture thereof.

46. The method of claim 44 wherein the inorganic acid is selected from the group consisting of hydrochloric acid, sulfuric acid, sodium bisulfate, potassium bisulfate, and mixtures thereof.

47. The method of claim 40 wherein the dairy mixture is acidified without fermentation to a pH of 4.3 or less with ED composition, inorganic acid or mixture thereof and at least one organic acid.

48. The method of claim 47 wherein the dairy mixture is acidified without fermentation to a pH of 4.2 or less with ED composition, inorganic acid or mixture thereof and at least one organic acid.

49. The method of claim 47 wherein the inorganic acid is selected from the group consisting of hydrochloric acid, sulfuric acid, sodium bisulfate, potassium bisulfate, and mixtures thereof.

50. The method of claim 47 wherein the organic acid is selected from a group consisting of lactic acid, acetic acid and mixtures thereof.

51. The method of claim 39 wherein the shelf stable cream cheese or cream cheese-like product further included added colorants, flavors, nutrients, antioxidants, herbs, spices, seafood, fruits, vegetables, nuts and/or other food additives.

52. A method for preparing a high moisture shelf stable milk or dairy product or composition comprising:
acidifying milk, milk derivatives, or mixtures thereof to a pH of 4.6 or less with acidic ED composition, inorganic acid, or mixtures thereof to provide an acidified mixture; and
adding at least one hydrocolloid stabilizer to the acidified mixture,
the milk product having a moisture content of 45% by weight or more, a water activity of at 0.9 or greater, and a total organic acid content of about 0.22 moles or less per 1000 grams of said product.

53. The method of claim 52 wherein the total organic acid content is about 0.12 moles per 1000 grams of said product.

54. The method of claim 52 wherein the milk, milk derivative or mixture thereof is acidified to a pH of 4.3 or less.

55. The method of claim 54 wherein the milk, milk derivative or mixture thereof is acidified to a pH of 4.2 or less.

56. The method of claim 52 wherein the milk is selected from the group consisting of fresh milk, dried milk, concentrated milk, and mixtures thereof.

57. The method of claim 52 wherein the milk derivative is selected from the group consisting of whey, whey protein concentrate, cheese curd, caseinate, butter milk, cream, butter, milk fat, and mixtures thereof.

58. The method of claim 52 wherein the inorganic acid is selected from the group consisting of hydrochloric acid, sulfuric acid, sodium bisulfate, potassium bisulfate, and mixtures thereof.

59. The method of claim 52 the milk or dairy product is heated to 165° F. or higher to pasteurize.

60. The method of claim 52 wherein the milk or dairy product further includes colorants, flavors, nutrients, antioxidants, herbs, spices, fruits, vegetables, nuts and/or other food additives.
